(19) United States
(12) Patent Application Publication
(10) Pub. No.: US 2010/0179981 A1
(43) Pub. Date: Jul. 15, 2010

(54) METHOD AND SYSTEM FOR PRESENTING CONTENT ON MOBILE COMMUNICATIONS DEVICES USING A MULTIMEDIA CONTENT DESCRIPTION LANGUAGE

(75) Inventor: Domingo Lopez Montesdeoca, Madrid (ES)

Correspondence Address: FOLEY HOAG, LLP;PATENT GROUP, WORLD TRADE CENTER WEST, 155 SEAPORT BLVD, BOSTON, MA, 02110, US

(73) Assignee: MOVIDILO S.L., Madrid (ES)

(21) Appl. No.: 12/353,721

(22) Filed: Jan. 14, 2009

(51) Int. Cl. G06F 15/16; G06F 17/21

(52) U.S. Cl. 709/203; 715/234

(57) ABSTRACT

A method is provided for presenting user interface content on a mobile device. The method includes: providing an editable text file in accordance with a markup layout definition language defining the user interface content to be presented on the mobile device and providing presentation instructions for the user interface content; and transmitting the text file over a wireless communications network to the mobile device to be interpreted by a client on the mobile device such that the user interface content can be displayed on the mobile device in accordance with the presentation instructions.

### BACKGROUND

The present application relates generally to mobile communications devices and, more particularly, to a method and system for presenting content on such devices using a multimedia content description language.

### BRIEF SUMMARY OF EMBODIMENTS OF THE INVENTION

In accordance with one or more embodiments of the invention, a method is provided for presenting user interface content on a mobile device. The method comprises: providing an editable text file in accordance with a markup layout definition language defining the user interface content to be presented on the mobile device and providing presentation instructions for the user interface content; and transmitting the text file over a wireless communications network to the mobile device to be interpreted by a client on the mobile device such that the user interface content can be displayed on the mobile device in accordance with the presentation instructions.

In accordance with one or more embodiments of the invention, a system is provided for presenting user interface content on mobile devices. The system comprises a server computer providing an editable text file in accordance with a markup layout definition language defining the user interface content to be presented on mobile devices and providing presentation instructions for the user interface content. The system also includes a plurality of mobile devices, each operated by a user communicating with the server computer over a wireless communications network for receiving the text file over the wireless communications network. Each of the mobile devices interprets the text file using a client on the mobile device such that the user interface content is displayed on the mobile device in accordance with the presentation instructions.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified block diagram of a wireless communications system in accordance with one or more embodiments of the invention.

FIG. 2 is a simplified logical block diagram of an exemplary mobile client application platform in accordance with one or more embodiments of the invention.

FIG. 3 is a schematic diagram illustrating element nesting in an MCD format file.

FIG. 4 illustrates an exemplary MCD application structure.

FIG. 5 illustrates exemplary successive screen images of a ticker.

FIG. 6 illustrates an exemplary MCD file for displaying the ticker screen images of FIG. 5.

FIG. 7 is a schematic diagram illustrating an exemplary box model used with MCD files.

### DETAILED DESCRIPTION

The present application relates generally to use of a multimedia content description (MCD) language or format (also referred to herein as a markup layout definition language) to define user interface content transmitted to mobile communications devices over wireless networks. The MCD format, which in some embodiments is an XML-based layout definition language, can be used to describe rich user interface content for efficient transmission over wireless networks and proper rendering on mobile devices.

Wireless networks have limitations both in terms of bandwidth and latency, and the MCD format provides a compact and powerful language definition for efficient transmission of user interface content over such networks. Content defined using the MCD format can be processed efficiently on mobile devices, which are typically resource constrained with limited memory, processor computational speed, and screen resolution.

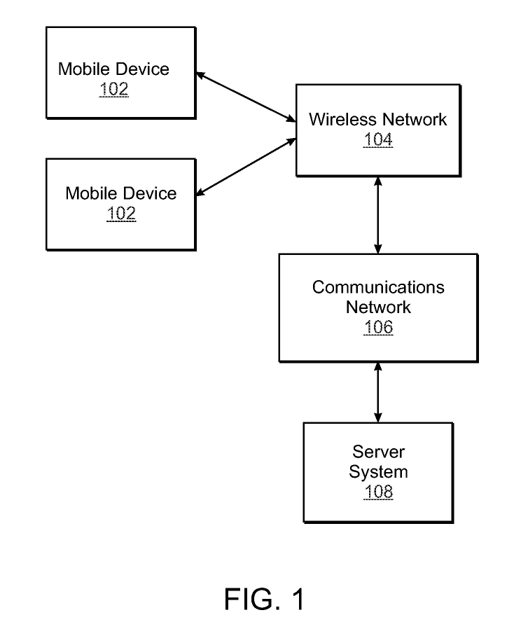

FIG. 1 is a block diagram of an exemplary communications system 100 in which various embodiments of the invention can be implemented. The system 100 includes a plurality of mobile communications devices 102, a wireless data network 104, a communications network 106, and a server system 108.

The mobile devices 102 can include a variety of portable computing devices capable of connecting to other computing devices and transmitting and receiving information. The mobile device 102 transmits information to and receives information from the server system 108 via the wireless data network 104 and the communications network 106. Examples of mobile devices 102 include portable devices such as, e.g., cellular telephones, smartphones, Personal Digital Assistants (PDAs), handheld computers, laptop computers, and the like.

The wireless data network 104 is configured to couple mobile devices 102 with the communications network 106. The wireless data network 104 can include any of a variety of networks including cellular communications networks, mesh networks, Wireless LAN (WLAN) networks, and the like. The wireless data network can further employ a plurality of access technologies including 2nd (2G), 3rd (3G) generation radio access for cellular systems, WLAN, Wireless Router (WR) mesh, and the like. Access technologies such as 2G, 3G, and future access networks can provide wide area coverage for mobile devices 102. For example, wireless data networks 104 can provide a radio connection through a radio network access such as Universal Mobile Telecommunications System (UMTS), Global System for Mobile communication (GSM), General Packet Radio Services (GPRS), Enhanced Data GSM Environment (EDGE), Wideband Code Division Multiple Access (WCDMA), and the like. In short, the wireless data network 104 can include virtually any wireless communication mechanism by which information may travel between mobile device 102 and another computing device, network, and the like, without limitation to any of the examples identified above.

The communications network 106 is configured to couple the server system 108 with other computing devices, including mobile devices 102, through the wireless network 104. The communications network 106 can be, e.g., the Internet, an intranet, or other network connection.

The mobile device and the server system can communicate using various communications protocols including but not limited to Hypertext Transfer Protocol (HTTP), HTTPS (Secure HTTP), and User-Datagram Protocol (UDP).

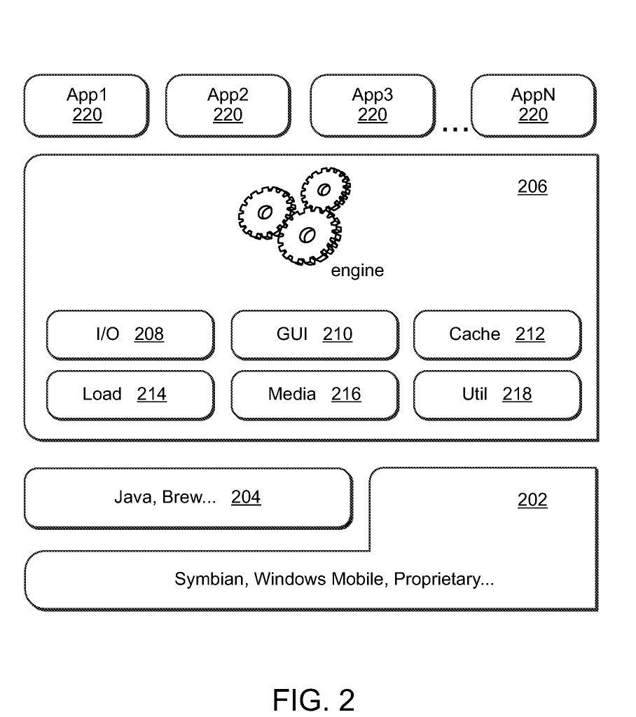

FIG. 2 is a simplified logical block diagram of an exemplary mobile client application platform stored in memory on a mobile device 102 in accordance with one or more embodiments of the invention. The mobile client application platform facilitates the running of applications such as rich client applications coded in MCD format and received over wireless networks. The platform includes a resident operating system 202 such as, e.g., Symbian, Windows Mobile, Android, or a proprietary operating system. The operating system controls the mobile device and interacts with the hardware controlling access to the file system, memory, the central processing unit, transmission channels, and allocating resources.

The mobile client application platform also includes an execution environment layer 204, which sits on the operating system. The execution environment layer 204 can provide uniform access to dissimilar operating systems, which can be particularly convenient for application developers. Some environments like Java SE can permit access to the operating system, and others such as the Java ME platform preclude such access via a so-called sandbox.

The MCD engine 206 is a client-side platform installed on the mobile device to interpret one of more applications in MCD format received from the server in order to display the user interface content defined by the files on the mobile device. The MCD engine 206 can be pre-installed on mobile devices distributed to customers or subsequently downloaded and installed by the customer.

The MCD engine 206 includes a plurality of components providing support for processing MCD files. These components can include an input-output module 208, which can add functionality to lower level input/output libraries. The MCD engine 206 can also include a GUI (graphical user interface) module 210, which can provide libraries needed for handling user input and output operations. These libraries can include implementations for screen elements like boxes, buttons, text rendering, custom fonts, user event dispatching and handling, visual effects, and graphical operations and algorithms. The MCD engine 206 can also include a load library 214, which provides upper level network input functionality for both synchronous and asynchronous downloading of resources and to interpret those resources once loaded. The MCD engine 206 can also include media libraries 216 for audio and video processing. These libraries assist with handling media management functions including image, audio, and video processing, speech recognition, and rendering algorithms like filtering, smoothing or antialiasing. The MCD engine 206 can also include utilities libraries 218 that can provide various types of unclassified functionalities including, e.g., logging utilities, predictive text input capabilities, and compression algorithms. The MCD engine 206 also includes cache libraries 212 for managing storage of frequently used content to reduce downloading over wireless networks. The cache libraries can include replacement policies, cache storage abstraction, and block management. In addition to these modules, the MCD engine 206 can include an MCD player to manage the execution flow, timelines, event and focus handling, clip life cycles (playing and stopping clips), scripting code execution, and CSS layout. The MCD engine 206 can also include various additional components.

One or more applications 220 can execute on the MCD engine 206. The applications 220 can be dynamically downloaded on the mobile device from the server. The applications 220 can preferably be downloaded without installing any software in the mobile device, with the MCD engine 206 managing the downloading and execution of the applications. The applications 220 can have a variety of purposes including, e.g., customer care, entertainment, searching, marketing, and games. The applications 220 are written using the MCD markup language, and can also include CSS positioning and JavaScript coding and make use of various types of available resources.

The MCD format is a layout definition language that concisely describes user interfaces to be presented on the mobile device. The MCD format is based on a markup language, preferably XML. XML is an industry standard formalizing and standardizing markup languages. The MCD format complies with the syntactic rules and conventions of the XML specification.

MCD format files can be authored or edited using various text editing tools such as EditPlus, XML Spy, Dreamweaver, or Eclipse.

The MCD format provides a concise syntax that can be efficiently transmitted over wireless networks and properly rendered in limited mobile devices. The MCD format provides a versatile set of tags and attributes, which allows elements of the user interface to be defined quickly and easily without the need of coding complex and bulky documents that are costly to transmit. The MCD format thereby more efficiently uses the limited and expensive bandwidth available for mobile devices on wireless networks. The MCD format's syntax keeps this simplicity without compromising its semantics, thereby providing developers with a great power and flexibility to build complex user interfaces with reduced code. With a reduced amount of code, use of the MCD format allows developers to specify eye-catching effects and appealing user interfaces effectively showcasing and exploiting the multimedia capabilities that the mobile device is equipped with.

In accordance with one or more embodiments of the invention, the MCD format can use layer distribution with z-ordering, providing a way to distribute complex content in a single screen. The MCD format defines a nested structure of elements, as do all XML-based formats. Among these elements are containers called clips. There is a top-level clip called clip-doc, which contains all other clips and elements. Every clip, in turn, can contain more elements and clips inside distributed following a z-order scheme, by which some of the elements are rendered on top of the others, hiding them as if they were positioned over them depending on their z-ordering; this ordering is alterable by means of the scripting language. This nesting cycle defines a tree in which the clip-root is the root and the ending clips and elements are the leaves.

By way of example, an element can comprise a portion of an image or text to be displayed on the screen of the mobile device. Elements share the timeline of a clip with other elements in the clip. For example, a clip may be a drop-down menu, and elements of the clip may be various options in the drop-down menu.

In accordance with one or more embodiments, the tree structure defined by the MCD format is rendered in such a way that the elements further away from the clip-root are displayed over all the elements that are closer to the clip-root. Sibling elements are rendered according to the precedence in the definition inside an MCD format file in a way that last defined elements are rendered over previously defined siblings. This kind of organization by assigning an upper-lower order relation is called the z-order. Every element in the MCD format file can be defined following a z-order convention. This order can be modified programatically via an scripting language.

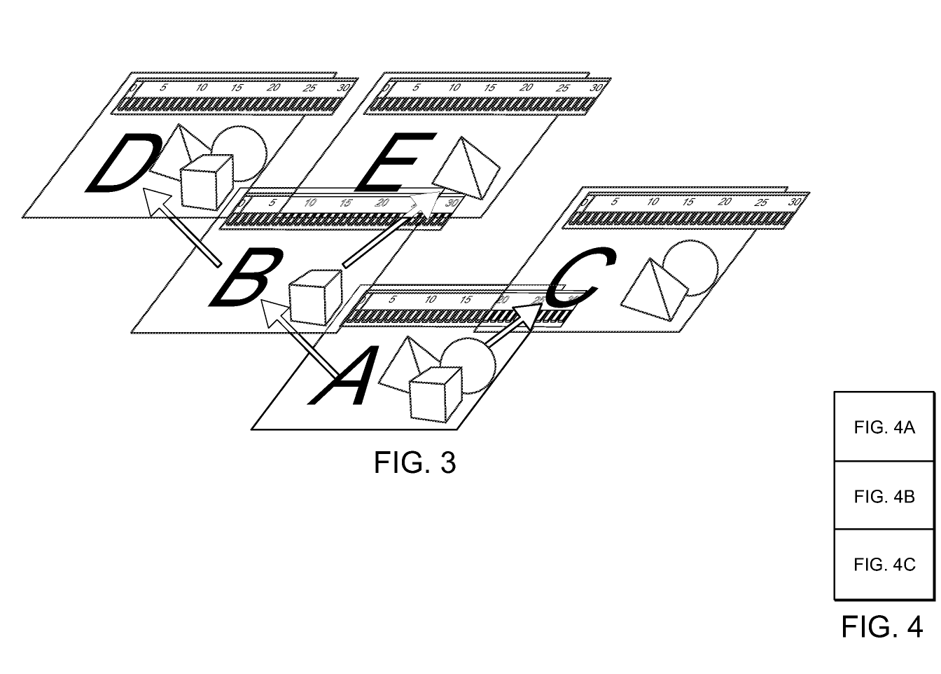

FIG. 3 schematically illustrates an MCD format tree-shaped structure showing element nesting. The figure shows a plurality of clips A, B, C, D, and E, each containing one or more elements and a timeline.

In accordance with one or more embodiments of the invention, the MCD format provides a timeline organization paradigm to better control the time evolution of every piece of content and its positioning and appearance during applications execution. Each clip includes a timeline. Timelines are composed of stills called frames that are ordered with an increasing index and that can be tagged with an identifier. Each element included in a clip defines its properties in some containing frame called key-frame of the parent clip, e.g., given that an “A” clip contains a “B” element, this element can have different coordinates and visual appearance parameters (alpha transparency, color, etc.) in two different frames defined in the container clip's timeline.

At any give time, clips could be in “stopped” or in “play” status. This status can be independent from one clip to another. Each clip has a header for each of its frames and which specifies the current frame. When a clip is in stopped status, the clip header does not advance. When a clip is in a play status, the header advances along the timeline. The header can be selectively placed in the timeline in accordance with scripting language.

In accordance with one or more embodiments, the MCD format provides the ability to define interpolations between frames. Interpolations involve two frames (initial and final frames), one element, and interpolation function. The interpolation mechanism calculates all the attributes applicable for all the frames that sit in between the initial and final frame for a particular interpolation according to the interpolation function and affects numeric attributes of the element defined in the interpolation. Interpolation functions can include, e.g., linear, cubic, and quadratic functions.

The frame rate is the rate by which the header advances to the next frame. The clips' timelines are independent of one another, i.e., the frame in which the time line header is located need not be the same for a different clip's timeline. The frame rate is the speed by which the header traverses the timeline. It is customizable by the application and for all clips is unique throughout application's execution.

In accordance with one or more embodiments, the MCD format includes Cascaded Style Sheets (CSS), allowing for the separation of the presentation definition from the content definition. The MCD format can separate presentation and content logic using CSS. The MCD format allows for the defining of the appearance of the elements included, by specifying a CSS syntax that can be written inside the MCD format file or as an external file to be loaded as a resource.

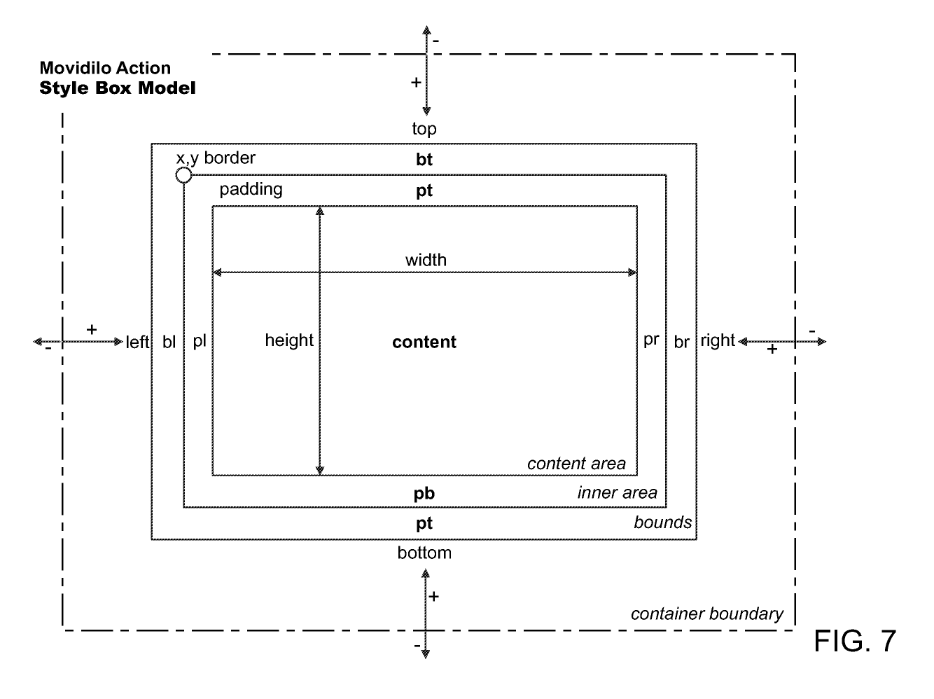

The CSS preferably conforms to a parallel specification based on W3C format (http://www.w3.org/Style/CSS/) but extending it to cater for all MCD-specific elements and possible parameters that define the presentation of a particular element. CSS sets a box model that is applicable to all the elements that make up the MCD. This box model states the definitions of various element layout concepts like padding, border, content, and position. These concepts are represented visually in FIG. 7.

In accordance with one or more embodiments, the MCD format includes custom font faces that define the appearance to be applied to text inside the MCD, overcoming text rendering limitations inherent in resource constrained mobile devices.

Unlike many XML formats and methodologies of defining user interfaces for both mobile phones and desktop environments, the MCD format can provide a unique way of specifying the appearance of text inside applications. In this regard, the MCD format can define a bit-map typeface format to provide the mobile device with new typefaces besides the often dull and jagged and limited font faces that are native to many mobile devices.

In accordance with one or more embodiments, a Bitmap Font (MBF) file can be referenced by the MCD and loaded on the mobile device alongside other resources like images, video and audio. The format specifies how text would be rendered, specifically: (1) the set of characters that are included and can be rendered using the typeface, supporting international glyphs; (2) the appearance of the characters through bit-map representations of the characters; and (3) the metrics that define the glyphs and that are needed to properly render the text using the particular MBF definition.

In accordance with one or more embodiments, the MCD format enables event dispatching, allowing advanced user interaction and event handling. In many systems with a graphical interface, events are generated and consumed along the whole life cycle of an application. Events are dispatched to the elements that are ready to consume them in an orderly fashion. This is usually called event propagation. Elements can choose to consume or not consume the events and an action can be scripted to associate some execution code to a particular event.

Events can be generated by the occurrence of, e.g., key strokes (pushing or releasing a key), clip header evolution (clip entering or exiting a frame in its timeline), clip activity initiation or termination (stopping, playing, loading), and other activities that take place in elements and that depends on the particular functionality (e.g., editing a text field, scrolling a scroll element, pressing a button, etc.).

In accordance with one or more embodiments, the MCD format enables focus management, allowing adaptable focus traversal throughout screens. There are clips that can gain focus and clips that cannot. In some interfaces, at any given time, only one clip inside an MCD file will be in focus, although any type of element within the MCD file can obtain such focus.

MCD files can be coded with actions written in a scripting language like JavaScript that respond to losing focus and gaining focus events. By default, the focus path order can be determined by the order in which the clips appear in the document. In some embodiments, the MCD syntax allows altering this order by code.

In general, when an XML-based document is enhanced with a scripting technology, the concept Document Object Model (DOM) commonly appears. The DOM is the structure the scripting sees in the form of object libraries and methods to manipulate and use the information related to the XML structure. It is a series of interfaces that sets a so-called Application Programming Interface (API) that can be used via one or more scripting languages to build additional functionality. Given that the scripting language of choice (JavaScript, VBScript, etc.) is independent of the DOM itself, some sort of language-neutral interface definition language like IDL can be used for that purpose. In one or more embodiments, the MCD format enables the Document Object Model definition to be exposed to procedural manipulation through scripting languages like JavaScript. This definition will provide the scripting developers with the ability to dynamically change content, elements like text-boxes, image positions, etc, and thereby enabling the designer to program complex behaviors, effects, and animations that might not be achievable by the exclusive use of the MCD static language. Having access to the MCD structure brings about the possibility of invoking the DOM API to perform actions like validating fields in a form. Thus, scripting can be used for instance to test that every parameter or value in a form (e.g., text fields, text areas, drop-down menus and the like) are well formed and abide by some rules applicable for that particular form.

The application logic could be divided into server side logic and client side logic. All of the client side logic could be developed using, e.g., the MCD format's script and DOM.

The scripting language integrated with the mobile client can also expose the lower level APIs to be manipulated with such scripting languages instead of full fledged object oriented languages. Functionalities like Bluetooth, file manipulation, message sending and receiving, graphic manipulation and all underlying APIs can be exposed this way.

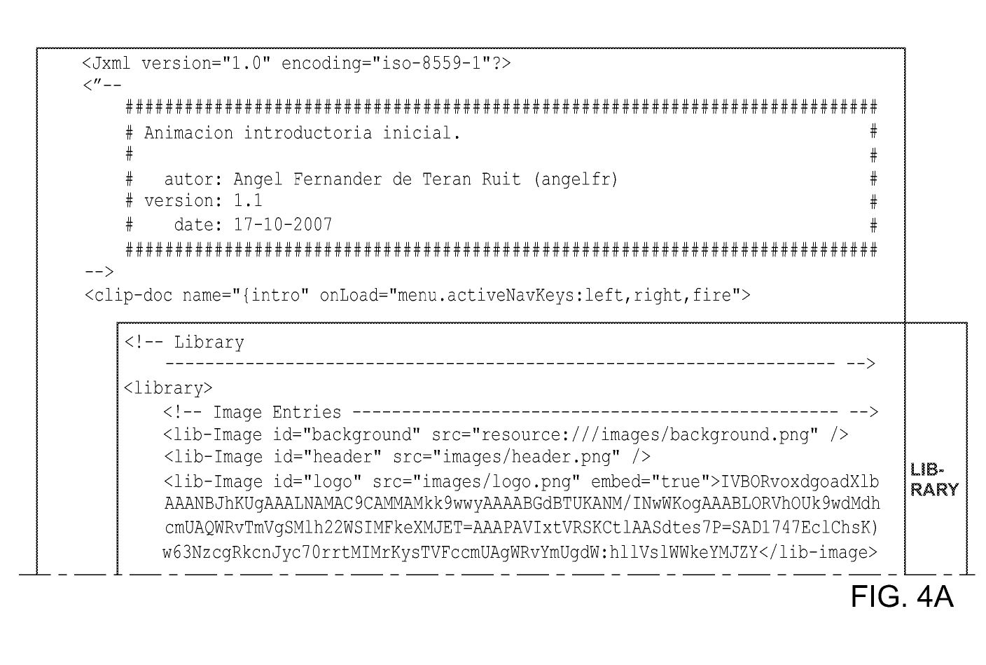

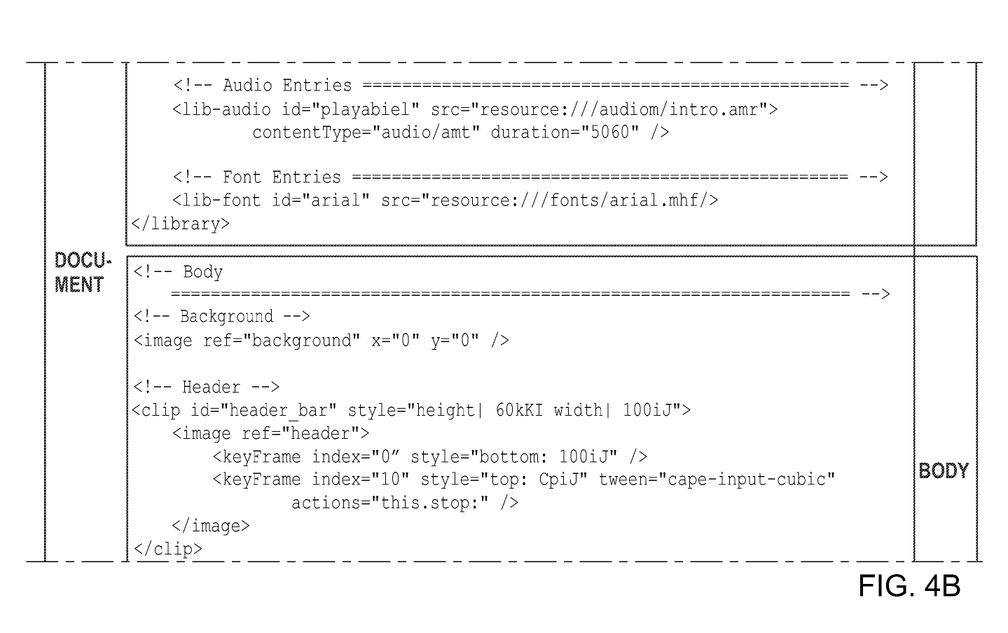

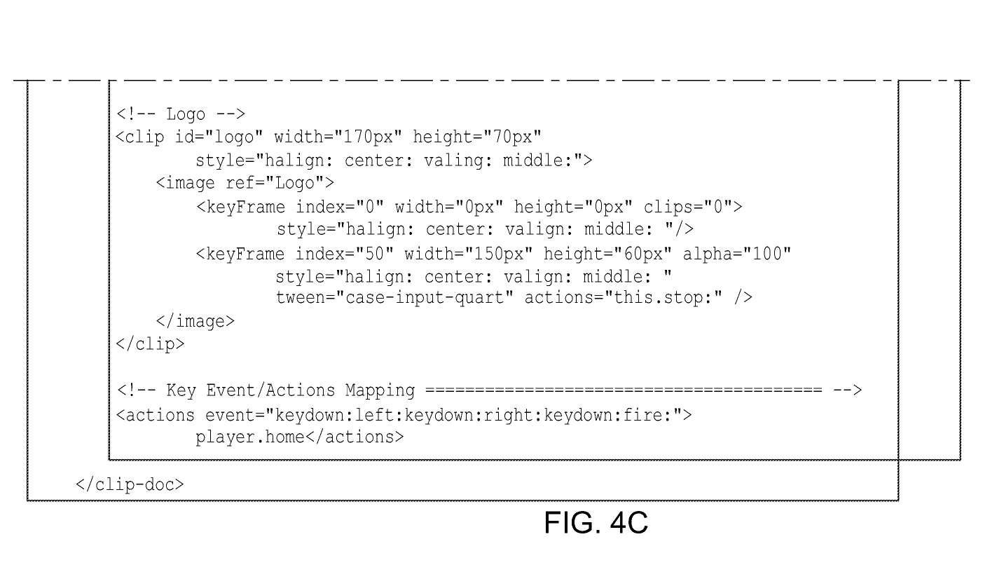

FIG. 4 illustrates an exemplary MCD format file structure. In this example, the element inside the <xml> tag is <clip-doc>, which has two main parts: the library and the document body. The library is declared using <library> and is the central point in which every resource to be used is declared. Use of the resources is specified later in the document. Various types of resources or varied formats can be specified including image files (e.g., in png format), audio files (e.g., in amr or mp3 formats), and bitmap fonts (e.g., in mbf format). The body of the document conveys various pieces of information, including a definition of all the visual elements (e.g., clips, text elements, text fields, actions, and key-frame definitions) and their behavior.

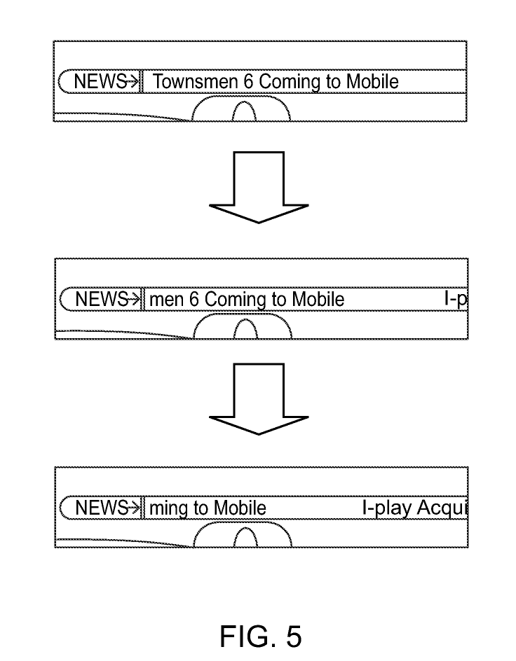

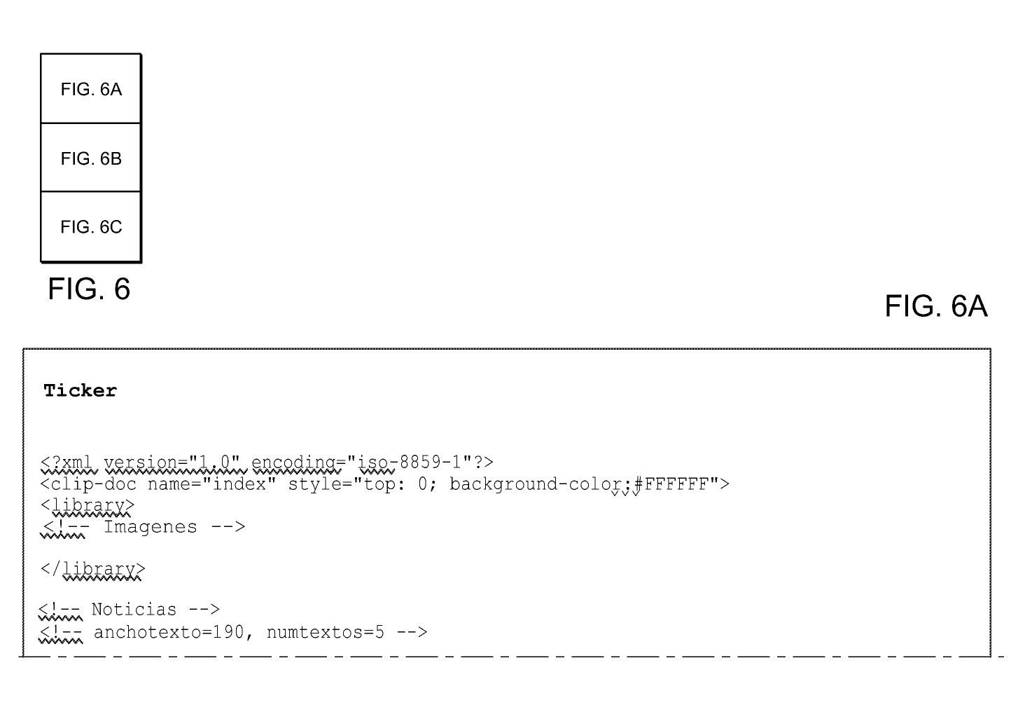

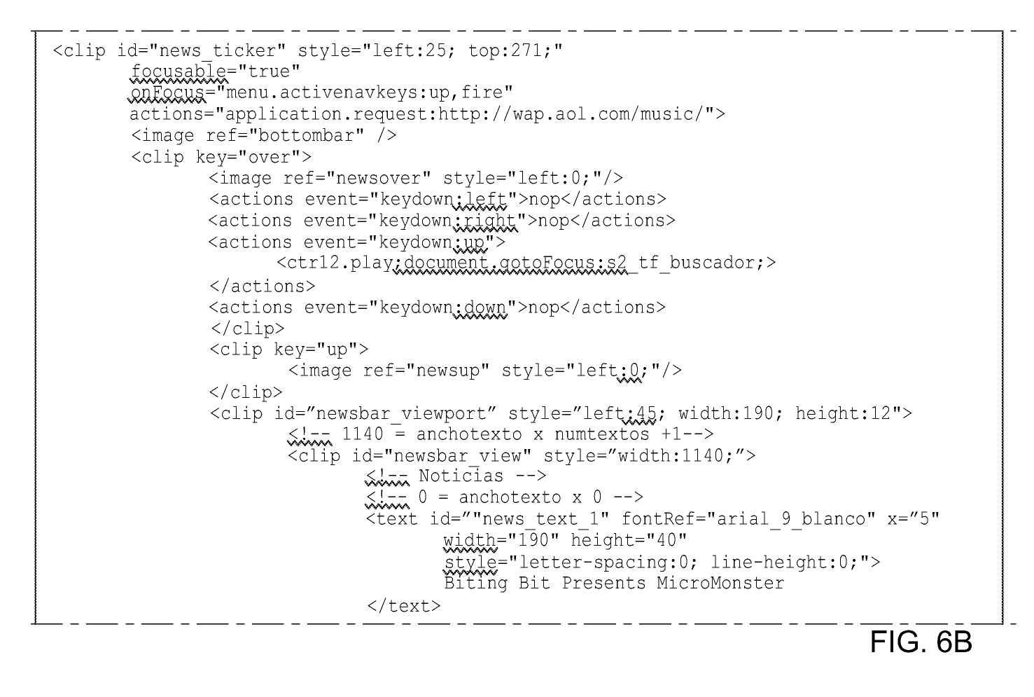

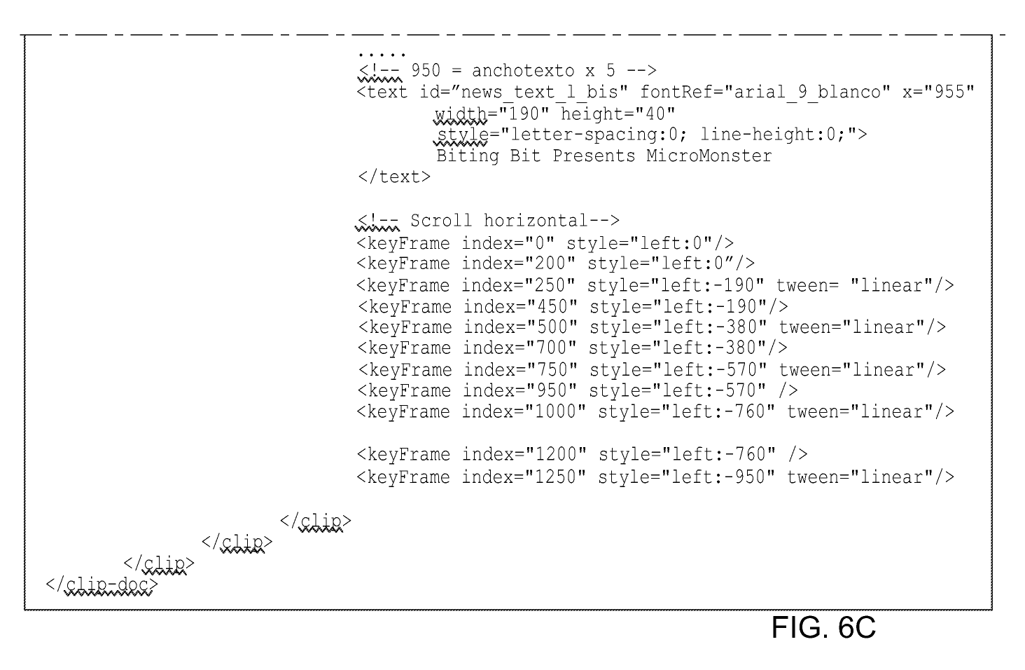

FIG. 5 illustrates an example of a commonly used ticker screen image displayed on a mobile device. This image is provided for illustrative purposes as an example of an image that can be rendered on the mobile device screen using an MCD format file. The ticker includes text that scrolls horizontally across the screen containing information such as, e.g., news, links, sports scores, and stock information. An MCD file for generating the ticker is provided in FIG. 6. In this file, a clip defining the scrolling text is included in another clip, which establishes limits with attributes or styles for the clips contained therein.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above may be implemented, e.g., in hardware, software, firmware, or any combination thereof.

Having described preferred embodiments of the present invention, it should be apparent that modifications can be made without departing from the spirit and scope of the invention.

What is claimed is:

1. A method of presenting user interface content on a mobile device, comprising:
providing an editable text file in accordance with a markup layout definition language defining the user interface content to be presented on the mobile device and providing presentation instructions for the user interface content; and
transmitting the text file over a wireless communications network to the mobile device to be interpreted by a client on the mobile device such that the user interface content can be displayed on the mobile device in accordance with the presentation instructions.

2. The method of claim 1 wherein the markup layout definition language is an XML-based layout definition language.

3. The method of claim 1 wherein the editable text file includes a nested structure of clips and elements within said clips representing portions of images to be displayed on the mobile device.

4. The method of claim 3 wherein each of the clips has a timeline comprising a plurality of ordered frames, wherein frames containing elements are key-frames, and wherein elements of one key-frame can have different attributes and properties than elements of another key-frame.

5. The method of claim 4 wherein a clip can have a stopped or play status independent of another clip using scripting instructions.

6. The method of claim 5 wherein each of said clips has a timeline, and when a clip has a play status, a header successively advances from one frame to another at a given rate.

7. The method of claim 4 wherein the markup layout definition language enables defining interpolations between key-frames.

8. The method of claim 3 wherein elements are rendered over other elements in accordance with a convention defined by the markup layout definition language.

9. The method of claim 1 wherein the markup layout definition language includes a bitmap typeface format to specify a plurality of typefaces for rendering text on the mobile device.

10. The method of claim 3 wherein the markup layout definition language defines clips to selectively gain and lose focus in accordance with gaining focus events and losing focus events, respectively.

11. The method of claim 1 wherein the markup layout definition language uses cascaded style sheets to separate the definition of the user interface content from the presentation instructions.

12. The method of claim 1 wherein the markup layout definition language can specify script routines downloaded on the mobile device to be executed when referenced in the text file.

13. A system of presenting user interface content on mobile devices, comprising:
a server computer providing an editable text file in accordance with a markup layout definition language defining the user interface content to be presented on mobile devices and providing presentation instructions for the user interface content; and
a plurality of mobile devices, each operated by a user communicating with the server computer over a wireless communications network for receiving the text file over the wireless communications network, each of said mobile devices interpreting the text file using a client on the mobile device such that the user interface content is displayed on the mobile device in accordance with the presentation instructions.

14. The system of claim 13 wherein the markup layout definition language is an XML-based layout definition language.

15. The system of claim 13 wherein the editable text file includes a nested structure of clips and elements within said clips representing portions of images to be displayed on the mobile device.

16. The system of claim 15 wherein each of the clips has a timeline comprising a plurality of ordered frames, wherein frames containing elements are key-frames, and wherein elements of one key-frame can have different attributes and properties than elements of another key-frame.

17. The system of claim 16 wherein a clip can have a stopped or play status independent of another clip using scripting instructions.

18. The system of claim 17 wherein each of said clips has a timeline, and when a clip has a play status, a header successively advances from one frame to another at a given rate.

19. The system of claim 16 wherein the markup layout definition language enables defining interpolations between key-frames.

20. The system of claim 16 wherein elements are rendered over other elements in accordance with a convention defined by the markup layout definition language.

21. The system of claim 13 wherein the markup layout definition language includes a bitmap typeface format to specify a plurality of typefaces for rendering text on the mobile device.

22. The system of claim 16 wherein the markup layout definition language defines clips to selectively gain and lose focus in accordance with gaining focus events and losing focus events, respectively.

23. The system of claim 13 wherein the markup layout definition language uses cascaded style sheets to separate the definition of the user interface content from the presentation instructions.

24. The system of claim 13 wherein the markup layout definition language can specify script routines stored on the mobile device to be executed when referenced in the text file.
